(19) United States
(12) Patent Application Publication
(10) Pub. No.: US 2024/0219792 A1
(43) Pub. Date: Jul. 4, 2024

(54) VARIABLE LIGHT DIFFUSING FILTER FOR CAMERAS

(71) Applicant: LC-TEC DISPLAYS AB, Borlänge (SE)

(72) Inventors: Jesper OSTERMAN; Alexander VIGANDER; Terry J. SCHEFFER, Hilo,, HI (US)

(21) Appl. No.: 18/043,546

(22) PCT Filed: Sep. 2, 2022
(86) PCT No.: PCT/US2022/075922

§ 371 Date: Mar. 16, 2023

Related U.S. Application Data
(60) Provisional application No. 63/241,437, filed on Sep. 7, 2021.

(51) Int. Cl. G02F 1/137; G02F 1/133; G02F 1/1337; G02F 1/1339

(52) U.S. Cl. CPC G02F 1/137; G02F 1/13306; G02F 1/1337; G02F 1/13394

(57) ABSTRACT

A variable light diffusing filter (100) for a camera (300) uses a liquid crystal device (102, 104, 172) in which the amount of diffusion can be readily controlled by varying the voltage (150) applied to the liquid crystal device.

### COPYRIGHT NOTICE

© 2022 LC-Tec Displays AB. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

The present disclosure relates to light diffusing filters and, in particular, to a variable light diffusing filter for a camera using a liquid crystal device in which the amount of diffusion can be readily controlled by varying the voltage applied to the liquid crystal device.

### BACKGROUND INFORMATION

In portrait photography, light diffusing filters placed in front of the camera soften the appearance of blemishes, wrinkles, and other imperfections in a subject's appearance. In indoor and outdoor scenes, light diffusing filters can evoke dreamy, ethereal, or even romantic feelings to a photograph. Despite the availability of software to digitally manipulate images, light diffusing filters continue to be used because better results can often be obtained in less time by selecting the proper light diffusing filter at the beginning and, if necessary, by making afterward small digital alterations to the photographic image.

Commercial light diffusing filters are readily available from several manufacturers and are available in a series of diffusing strengths. Initially, light diffusing filters consisted of simple woven fabric of various mesh sizes that were placed over the camera lens. Such filters are still available in more robust forms by sandwiching the fabric between two round glass plates in screw-on type frames for conventional cameras or between rectangular plates for commercial video cameras. Other light diffusing filters are made by patterning glass in a variety of ways. In all these light diffusing filters, a large fraction of the filter area lets incident light rays pass through the filter without divergence, while a much smaller fraction of the incident rays undergoes varying degrees of divergence. In this way, the resulting image is softened while simultaneously preserving its sharpness and contrast.

Depending upon the lighting conditions and camera optics, there is a need to manually change filters having different strengths to obtain the result desired, especially in outdoor scenes where the lighting conditions are constantly changing. This can be a cumbersome and time-consuming procedure.

### SUMMARY OF THE DISCLOSURE

The variable light diffusing filter of the present disclosure includes a liquid crystal device, a mounting assembly to attach the liquid crystal device to a camera, and a variable voltage source. A liquid crystal cell includes two planar transparent substrates separated from each other by spacer elements, optically transparent electrodes, and liquid crystal alignment layers. Each substrate and optically transparent electrode together forms an electrode structure having an interior on which one of the alignment layers is formed. A perimeter seal seals a nematic liquid crystal mixture that is filled between the liquid crystal alignment layers. The individual spacer elements are mutually spaced apart from one another, on average, by at least four times the diameter of the spacer elements, which are preferably of spherical shape.

The alignment layers are conditioned to orient surface-contacting liquid crystal directors to provide a translationally invariant director field over the active area of the liquid crystal device. A translationally invariant director field means that, in any given plane parallel to the inner surfaces of the substrates, the nematic directors are uniformly oriented in the same direction. The translationally invariant director field exhibits an optical property that results in no effect on the angle of the light passing through the nematic liquid crystal mixture, i.e., light rays incident on the director field at one angle leave it at the same angle.

If spacer elements are introduced, however, the translationally invariant director field is disrupted in the vicinity of the spacer elements because of mismatches between the surface alignment directions at the spacer elements and the alignment directions of surface non-contacting directors elsewhere in the translationally invariant director field. Because the surface non-contacting directors are coupled to one another by elastic forces, the area of a site disruption extends outward several times the diameter of the spacer elements. The orientation of the surface non-contacting directors in the disrupted areas continuously changes in the lateral directions, and since the liquid crystal mixture is birefringent, the effective refractive index also changes in the lateral direction. This results in liquid crystal lens-like properties in the regions of disruption and causes divergence of the incident light rays propagating through these regions. Increasing the voltage applied to the liquid crystal device decreases the areas of the regions of disruption, and consequently decreases divergence of light passing through the liquid crystal device, because the forces of the electric field on the surface non-contacting directors are larger than the elastic forces causing the disruption. The result is that a larger area of the display converts to a translationally invariant director field structure that does not diffuse the incident light propagating through it. This is how the disclosed variable light diffusing filter electrically controls the amount of diffusion.

Additional aspects and advantages will be apparent from the following detailed description of preferred embodiments, which proceeds with reference to the accompanying drawings.

### BRIEF DESCRIPTION OF THE DRAWINGS

FIG. 1 is a schematic diagram of an embodiment of the disclosed liquid crystal light diffusing filter (not to scale) showing, in the vicinity of the spacer elements, regions of disruption of a translationally invariant nematic director field (shaded areas) with no voltage applied to the liquid crystal light diffusing filter, leading to a divergence of incident light propagating through these disrupted director field regions.

FIG. 2 shows the liquid crystal light diffusing filter of FIG. 1, to which is applied a voltage, V, that decreases the sizes of the disrupted director field regions and thereby decreases the amount of light diffusion.

FIGS. 3A and 3B are diagrams presenting enlarged fragmentary views of a portion with one spacer element of the light diffusing filter of FIG. 1, showing the director field in, respectively, field-aligned and relaxed states of a twisted nematic layer of liquid crystal material.

FIG. 4 is a series of eight photographs of a light source emitting light in a scene, the photographs showing different amounts of diffused emitted light taken by a camera with the disclosed variable light diffusing filter positioned in front of the camera lens and operating at corresponding different applied voltages.

FIG. 5 is a graph showing quantitative measurements of the diffusion imparted to incident light by the disclosed variable light diffusing filter, the diffusion expressed in percentage amount as a function of applied voltage.

FIG. 6 shows a partly exploded view of the light diffusing filter of FIG. 1, configured for mounting on a lens of a high-end cinema or video camera.

### DETAILED DESCRIPTION OF PREFERRED EMBODIMENTS

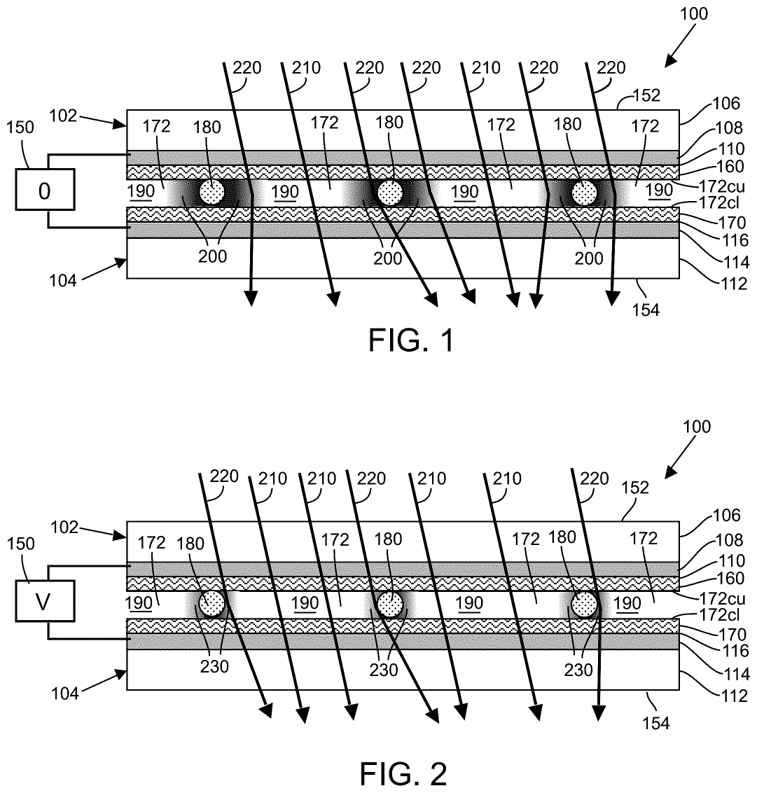

FIG. 1 is a schematic diagram (not to scale) of a portion of a variable light diffusing filter 100 having a first or upper electrode structure 102 and a second or lower electrode structure 104. Electrode structure 102 includes a planar transparent substrate 106 having an inner surface that is covered by an optically transparent electrode layer 108 to form an interior surface 110 of electrode structure 102. Electrode structure 104 includes a planar transparent substrate 112 having an inner surface that is covered by an optically transparent electrode layer 114 to form an interior surface 116 of electrode structure 104. Electrode layers 108 and 114 are connected to a variable voltage source 150. An outer surface 152 of substrate 106 and an outer surface 154 of substrate 112 form, respectively, a light entrance surface and a light exit surface of light diffusing filter 100.

Electrode layers 108 and 114 are covered with, respectively, a first or upper liquid crystal alignment layer 160 and a second or lower liquid crystal alignment layer 170. A layer of nematic liquid crystal material having directors 172 is confined between alignment layers 160 and 170. Alignment layer 160 and alignment layer 170 are conditioned to impart to, respectively, upper surface-contacting directors 172cu and lower surface-contacting directors 172cl a uniform liquid crystal alignment direction that results in a translationally invariant director field, i.e., directors 172 in any given plane parallel to substrates 106 and 112 always point in the same direction. Substrates 106 and 112 with their respective transparent electrode layers 108 and 114 and alignment layers 160 and 170 are separated by spacer elements 180 (shown as balls here), and the remaining volume between substrates 106 and 112 is filled with the nematic liquid crystal material. For clarity, the perimeter seal and antireflective layers associated with typical liquid crystal devices are not shown.

With variable voltage source 150 set to 0 V, as illustrated in FIG. 1, the director field over large areas of open spaces 190 in light diffusing filter 100, excluding regions 200 (darker areas in FIG. 1) in the vicinity of spacer elements 180, is translationally invariant and so does not alter the direction of incident light rays 210 passing though these large regions, as also occurs in the open areas in a conventional fabric mesh filter. Images formed by light rays 210 propagating through these large regions of open spaces 190 will remain sharp with maximum contrast. But in regions 200 of the liquid crystal material in the vicinity of spacer elements 180 up to several spacer element diameters, the translationally invariant liquid crystal director field is disrupted owing to the elastic constants of the liquid crystal material and the different director alignment directions at spacer elements 180 and those at conditioned surfaces 172cu and 172cl of alignment layers 160 and 170. This disruption in director alignment changes the effective refractive index of light 220 passing through these disrupted regions and refracts the incoming light with a deviation from its original direction. The refraction taking place in the vicinity of spacer elements 180 has a similar diffusing effect to that of the fibers in fixed-mesh camera filters.

FIG. 2 illustrates the case in which variable voltage source 150 is set to higher voltage magnitudes. The director field in open spaces 190 between spacer elements 180 is still translationally invariant, but the smaller disrupted regions 230 (dark, narrower areas in FIG. 2) around spacer elements 180 cause less divergence of light 220. This is so because the strong torque on directors 172 from the electric field induced by voltage source 150 overcomes the weaker torque on directors 172 from the elastic forces generated by the different director alignment directions at spacer elements 180 and at alignment layers 160 and 170 on the respective substrates 106 and 112. This result is less director field disruption with less light diffusion. Referring again to the mesh filter analogy, the effect is as though the threads of the mesh filter became finer, resulting in less light diffusion.

In one embodiment, the azimuthal alignment directions of polyimide alignment layers 160 and 170 are arranged to form a 90-degree angle when no voltage is applied across electrode layers 108 and 114, causing the liquid crystal director field inside light diffusing filter 100 to have 90-degree twisted nematic configuration. The liquid crystal material is a nematic liquid crystal having a positive dielectric anisotropy of 9.9 and a birefringence of 0.099, at λ=589 nm and 20° C.

### Prototype Embodiment and Diffusion Measurements Example

A prototype embodiment of the disclosed variable light diffusing filter 100 uses 0.7 mm-thick glass substrates 106 and 112 with their upper and lower inner surfaces coated with Indium-Tin Oxide (ITO) conductive optically transparent electrode layers 108 and 114. ITO layers 108 and 114 are covered with polyimide alignment layers 160 and 170 in contact with nematic liquid crystal material directors 172 having positive dielectric anisotropy. In this prototype embodiment, the polyimide is rubbed to align surface-contacting directors 172_{cu} and 172_{cl} of the liquid crystal material parallel to the rubbing direction, and the rubbing directions of upper and lower polyimide alignment layers 160 and 170 are set at right angles to each other. The two coated substrates 106 and 112 are spaced apart by 5.0 μm-silica spacer balls 180, randomly, i.e., nonuniformly, distributed over the surface area of light diffusing filter 100, with a density of approximately 200 spacers/mm². Except for regions 200 around spacer elements 180, the director field between substrates 106 and 112 adopts a twisted structure like the structure inside conventional twisted nematic liquid crystal displays. The liquid crystal mixture is a commercial mixture having a positive dielectric anisotropy of 9.9 and a birefringence of 0.099, at λ=589 nm and 20° C. Electrical contact to first and second electrode layers 108 and 114 is made to variable voltage source 150 that generates a 60 Hz alternating square wave voltage. There is no selective polarization state blocking of incoming light propagating for incidence on outer surface 152 of substrate 106 or of light propagating from outer surface 154 of substrate 112. In other words, unlike the standard twisted nematic liquid crystal display, there are no polarizers associated with the disclosed variable light diffusing filter 100, including this prototype embodiment.

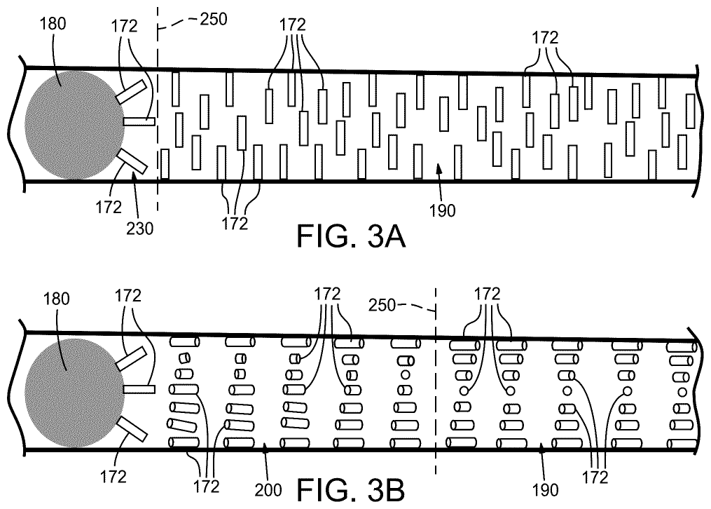

FIGS. 3A and 3B show the director field in, respectively, field-aligned (source 150 at >0V) and relaxed (source 150 at 0V) states of a fragmentary portion of the prototype example of a twisted nematic layer of liquid crystal material having a positive dielectric anisotropy. For clarity, the portion shown in FIGS. 3A and 3B includes one spacer element 180, and directors 172 in vicinity of spacer element 180 are shown perpendicular to it. A vertical dashed line 250 indicates an area of transition between disrupted regions 230 (FIG. 3A) and 200 (FIG. 3B) and translationally invariant open spaces 190. In FIG. 3A, a voltage is applied to the electrodes (not shown) producing perpendicular alignment of surface non-contacting directors 172 everywhere in the liquid crystal layer, resulting in a large open space 190 where the liquid crystal director field is translationally invariant, except region 230 very near spacer element 180 where the translationally invariant director field is disrupted. In FIG. 3B, no voltage is applied to the electrodes (not shown). In open space 190 farther away from spacer element 180, the director field adopts a 90° twisted nematic structure that is translationally invariant, but the elastic forces resulting from the disparity of the alignment directions at the surface of spacer element 180 and the alignment direction at the layer upper and lower boundaries produces an extensive disrupted region 200 that is not translationally invariant.

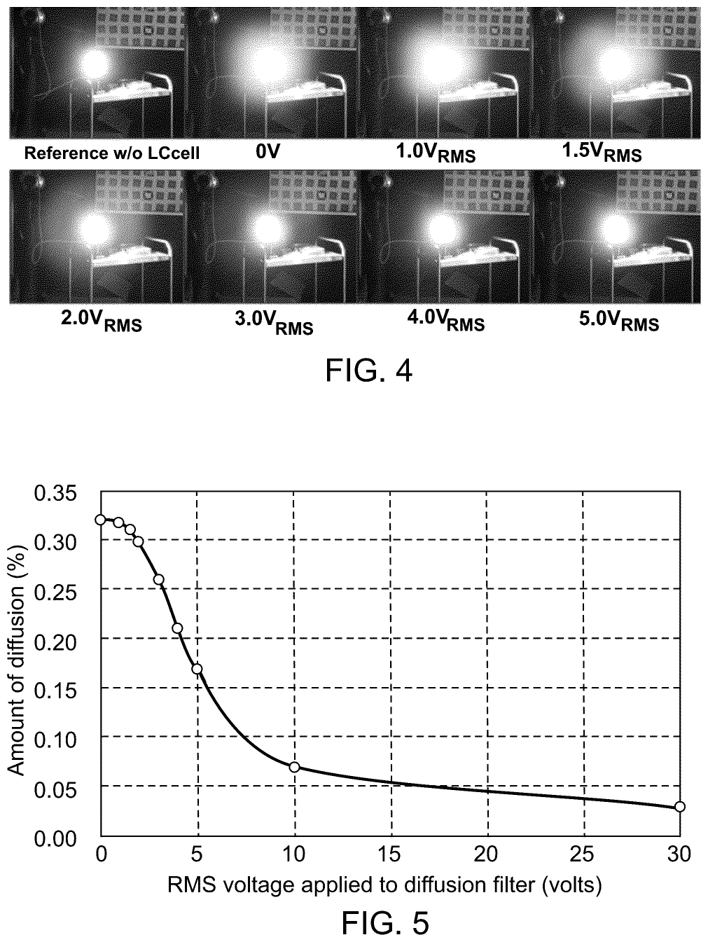

FIG. 4 shows a series of eight photographs of a scene containing a light source, the photographs taken with a camera outfitted with the prototype variable light diffusing filter 100 in front of the camera lens. The minimal amount of haze or diffusion seen around the light source with 5.0 V_{RMS} applied is comparable to the amount diffusion obtained when the variable light diffusing filter is completely removed from the camera lens. As can be seen in FIG. 4, decreasing the voltage applied to the variable light diffusing filter prototype substantially increases the diffusion, which plateaus around 0 to 1 V_{RMS}. It is noteworthy that the structural details of the table holding the light source remain sharp without loss of contrast, regardless of the amount of diffusion.

FIG. 5 is a graph showing quantitative diffusion measurements as a function of voltage, the measurements made on the same prototype device previously described and used in taking the photographs shown in FIG. 4. The diffusion measurements are based on the operating principle of a haze meter, which measurements entail shining a collimated light beam through the variable light diffusing filter, collecting the diffused light inside an integrating sphere, and measuring with a photodetector the intensity of the diffused light. The collimated undiffused light passes through the sphere to a light trap and is not measured. The measurements are calibrated by measuring the light reflected inside the sphere by removing the sample and replacing the light trap with a reflectance standard. As FIG. 4 illustrates, the amount of diffusion is about 0.32% in the 0 to 1 V_{RMS} region.

A skilled person will understand that many possible variations can be realized with the disclosed variable light diffusing filter. Many of the variations described below will have a significant impact on the dynamic range of the light diffusing filter, as well as the amount of the diffusion. Regarding spacer elements 180, for example, the randomly distributed spacer balls could have diameters in the range of 1 μm-100 μm, could be made of opaque rather than transparent material, and could be made of polymeric material rather than silica. Spacer elements 180 could also be preconditioned to provide homogeneous or homeotropic alignment at their surfaces. The randomly distributed spacer density could also be varied between 2 spacers/mm² and 10,000 spacers/mm². Alternatively, spacer posts could be used rather than spacer balls, and the spacer posts could be deposited photolithographically or by other means to achieve a wide range of heights, diameters, patterns, and densities.

Transparent substrates 106 and 112 could be made of glass or other transparent material such as polymer material. Optically transparent electrode layers 108 and 114 could be Indium-Tin Oxide (ITO) or some other transparent conducting material, such as Zinc Oxide (ZnO). Possible alignment layers 160 and 170 providing surface-contacting director alignment parallel to the surface include polyimide or other polymers or even obliquely deposited inorganic materials, such as SiO or SiO₂. Alternatively, alignment layers 160 and 170 providing surface-contacting director alignment perpendicular to the surface include specially formulated polyimides and the surfactant DMOAP.

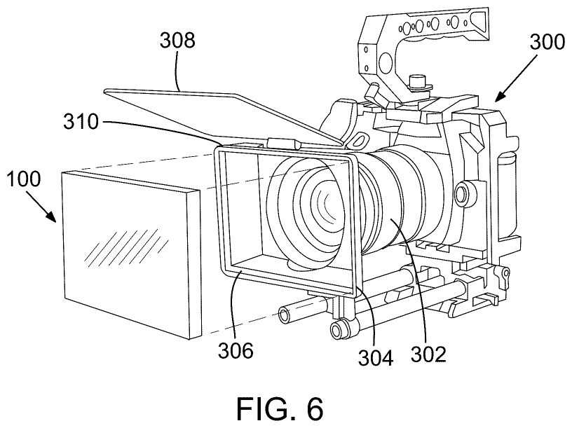

FIG. 6 shows a partly exploded view of light diffusing filter 100 configured for operative connection to a high-end cinema or video camera 300 positioned in the field of view of its lens 302. A structure known to photographers as a matte box 304 is mounted on lens 302 at its light-receiving end to block the sun or other light source and thereby prevent glare and lens flare. Light diffusing filter 100 is fitted against a shoulder portion 306 formed within matte box 304 to close its open end. A moveable lens cap 308 is hinge mounted to a top side 310 of matte box 304 to cover and thereby prevent scratching of light diffusing filter 100 when camera 300 is not in use. Variable voltage source 150, including a battery, AC voltage generator, and voltage output control, could be part of matte box 304 or located in a separate module (not shown) mounted externally to light diffusing filter 100 itself.

Alternatively, variable light diffusing filter 100 can be made in circular shape and mounted, together with its associated electronics, inside a screw-on ring with the appropriate diameter for the specific camera lens. Light diffusing filter 100 could also be mounted behind camera lens 302, directly in front of photographic film or an electronic sensor array.

It will be obvious to those having skill in the art that many changes may be made to the details of the above-described embodiments without departing from the underlying principles of the invention. The scope of the present invention should, therefore, be determined only by the following claims.

1. A variable light diffusing filter, comprising:
a liquid crystal device through which incident light propagates and which includes first and second electrode structures having respective first and second interior surfaces;
a first alignment layer formed on the first interior surface of the first electrode structure, and a second alignment layer formed on the second interior surface of the second electrode structure;
multiple mutually spaced-apart spacer elements positioned between the first and second alignment layers to separate the first and second electrode structures and form open spaces between adjacent ones of the spacer elements;
nematic liquid crystal directors confined between the first and second alignment layers and filling the open spaces between the spacer elements, the liquid crystal directors forming a director field and including surface-contacting directors that contact the first and second alignment layers, the first and second alignment layers conditioned to orient the surface-contacting directors to provide a translationally invariant director field that undergoes director alignment disruptions in regions of the filled open spaces, the regions of director alignment disruptions located in vicinity of the spacer elements; and
in response to a signal of varying magnitude applied to the electrode structures, the regions of director alignment disruptions change in size and thereby change by a corresponding amount of divergence the light propagating through the liquid crystal device without affecting the light propagating through the liquid crystal directors outside the regions of director alignment disruptions.

2. The variable light diffusing filter of claim 1, in which the spacer elements are nonuniformly distributed between the first and second alignment layers.

3. The variable light diffusing filter of claim 1, in which the first electrode structure includes a first substrate having a first outer surface and the second electrode structure includes a second substrate having a second outer surface, and in which there is no polarization state blocking of incoming light propagating for incidence on the first outer surface of the first substrate or of light propagating from the second outer surface of the second substrate.

4. The variable light diffusing filter of claim 1, further comprising a camera having a lens with a field of view, the camera operatively connected to a mounting structure configured to receive the light diffusing filter and position it in the field of view of the lens.

5. The variable light diffusing filter of claim 4, in which the mounting structure includes a matte box.

6. The variable light diffusing filter of claim 5, in which the signal of varying magnitude is provided by a voltage source that forms part of the matte box.

7. The variable light diffusing filter of claim 1, in which azimuthal alignment directions of the conditioned first and second alignment layers are arranged to form a 90-degree angle when the signal of varying magnitude applied to the first and second electrode structures is of zero magnitude and thereby impart to the nematic liquid crystal directors a 90-degree twisted nematic configuration.

8. The variable light diffusing filter of claim 1, in which the spacer elements have a diameter, and in which the spacer elements are on average mutually spaced apart by at least four times the diameter of the spacer elements.

9. The variable light diffusing filter of claim 1, in which the spacer elements are made of opaque material.

10. The variable light diffusing filter of claim 1, in which the spacer elements are made of transparent material.

11. The variable light diffusing filter of claim 1, in which the spacer elements are made of silica.

12. The variable light diffusing filter of claim 1, in which the spacer elements are made of polymeric material.

13. The variable light diffusing filter of claim 1, in which the spacer elements are randomly distributed between the first and second alignment layers.

14. The variable light diffusing filter of claim 13, in which the random distribution of the spacer elements varies between about 2 spacer elements/mm² and about 2000 spacer elements/mm².

15. The variable light diffusing filter of claim 1, in which the spacer elements have surfaces that are preconditioned to provide homogenous alignment at the surfaces.

16. The variable light diffusing filter of claim 1, in which the spacer elements have surfaces that are preconditioned to provide homeotropic alignment at the surfaces.

17. The variable light diffusing filter of claim 1, further comprising a voltage source configured to apply to the electrode structures a selectable voltage that provides the signal of varying magnitude.

18. The variable light diffusing filter of claim 17, in which the selectable voltage includes first and second RMS voltages that are different from each other, the first RMS voltage corresponding to a first diffusion setting and the second RMS voltage corresponding to a second diffusion setting that is different from the first diffusion setting.

19. The variable light diffusing filter of claim 17, in which the selectable voltage includes square wave voltages of different peak amplitudes.

20. The variable light diffusing filter of claim 19, in which the square wave voltages are 60 Hz square wave voltages.
